(19) United States
(12) Patent Application Publication
(10) Pub. No.: US 2020/0217064 A1
(43) Pub. Date: Jul. 9, 2020

(54) SOUNDPROOFING DEVICE

(71) Applicant: TOYOTA JIDOSHA KABUSHIKI KAISHA, Toyota-shi (JP)

(72) Inventors: Fusahiro TSUKANO, Susono-shi (JP); Hiroshi TAKEKAWA, Toyota-shi (JP); Yu MIYAHARA, Susono-shi (JP); Yuya TAKAHASHI, Susono-shi (JP); Akinori GOTO, Susono-shi (JP)

(73) Assignee: TOYOTA JIDOSHA KABUSHIKI KAISHA, Toyota-shi (JP)

(21) Appl. No.: 16/703,318

(22) Filed: Dec. 4, 2019

(30) Foreign Application Priority Data
Jan. 7, 2019 (JP) 2019-000692

(51) Int. Cl. E04B 1/84; G10K 11/16

(52) U.S. Cl. CPC E04B 1/84; E04B 2001/8485; G10K 11/16

(57) ABSTRACT

A soundproofing device according to the present disclosure includes a Helmholtz resonator including: a wall that forms a Helmholtz resonance chamber; and a first opening formed in the wall so as to cause the Helmholtz resonance chamber to communicate with an outside of the Helmholtz resonance chamber. At least a part of the wall is configured by a sound source member that radiates sound. The Helmholtz resonator includes: one or more partition walls formed so as to divide the Helmholtz resonance chamber into a plurality of regions, and a second opening formed in the one or more partition walls so as to cause the plurality of regions to communicate with each other.

### CROSS-REFERENCE TO RELATED APPLICATION

The present disclosure claims priority under 35 U.S.C. § 119 to Japanese Patent Application No. 2019-000692, filed on Jan. 7, 2019. The content of which is incorporated herein by reference in its entirety.

### BACKGROUND

### Technical Field

The present disclosure relates to a soundproofing device, and more particularly to a soundproofing device using Helmholtz resonance.

### Background Art

WO 2012/144078 A1 discloses a soundproofing device including a Helmholtz resonator. This Helmholtz resonator has an opening for causing a part of a cavity (Helmholtz resonance chamber) to communicate with the outside. In this resonance chamber, a sound emission part (sound source) which is a soundproofing object is arranged.

According to the Helmholtz resonator configured as described above, the following effect can be obtained by causing the sound source to exist inside the Helmholtz resonator. That is to say, when a sound having a frequency higher than a Helmholtz resonance frequency is generated, the sound in the resonance chamber becomes difficult to propagate to the outside due to the inertial effect of the air in the opening of the Helmholtz resonator. As a result, a soundproofing effect can be achieved in a wide frequency band located on the high frequency side of the Helmholtz resonance frequency.

### SUMMARY

If, as in the Helmholtz resonator disclosed in WO 2012/144078 A1, at least a part of a wall forming the Helmholtz resonance chamber is configured by a sound source member, a soundproofing effect can be achieved in a wide frequency band located on the high frequency side of a Helmholtz resonance frequency. On the other hand, air column resonance is generated in the Helmholtz resonance chamber. As a result, the soundproofing effect may be lowered in a frequency band located around an air column resonance frequency.

The present disclosure has been made in view of the problem described above, and an object of the present disclosure is to reduce a decrease in the soundproofing effect caused by air column resonance in a soundproofing device including a Helmholtz resonator in which at least a part of a wall forming a Helmholtz resonance chamber is configured by a sound source member.

A soundproofing device according to the present disclosure includes a Helmholtz resonator including: a wall that forms a Helmholtz resonance chamber; and a first opening formed in the wall so as to cause the Helmholtz resonance chamber to communicate with an outside of the Helmholtz resonance chamber. At least a part of the wall is configured by a sound source member that radiates sound. The Helmholtz resonator includes: one or more partition walls formed so as to divide the Helmholtz resonance chamber into a plurality of regions, and a second opening formed in the one or more partition walls so as to cause the plurality of regions to communicate with each other.

The Helmholtz resonance chamber may include a first direction and a second direction shorter than the first direction. At least one of the one or more partition walls may also be formed so as to extend in a direction perpendicular to the first direction.

The one or more partition walls may include a plurality of partition walls. The plurality of partition walls may also be arranged at unequal intervals.

The plurality of regions may include a first region, and one or a plurality of second regions located outside the first region. The first region may also be wholly covered by the one or a plurality of second regions with at least one of the one or more partition walls interposed between the first region and the one or a plurality of second regions.

The one or more partition walls may have a honeycomb cross-sectional shape.

The Helmholtz resonator included in the soundproofing device according to the present disclosure includes one or more partition walls formed to divide a Helmholtz resonance chamber into a plurality of regions. Also, the plurality of regions communicate with each other through the second opening. The installation of this kind of partition walls shortens the length of an air column in a specific direction in the Helmholtz resonance chamber. If the length of the air column is shortened, the air column resonance frequency increases. Therefore, one or more peaks of sound power level caused by the air column resonance can be shifted to the high frequency side. As a result, according to the soundproofing device of the present disclosure, it is possible to reduce a decrease in the soundproofing effect caused by the air column resonance in the low frequency band.

### BRIEF DESCRIPTION OF THE DRAWINGS

FIG. 1 is a cross-sectional view that schematically illustrates an example of a shape of a Helmholtz resonator using a soundproofing principle used as a premise in a soundproofing device according to the present disclosure;

FIG. 2 is a graph used to explain a soundproofing effect by the Helmholtz resonator shown in FIG. 1;

FIG. 3 is a graph used to explain an issue caused by air column resonance;

FIG. 4 is a perspective view that schematically illustrates the configuration of a Helmholtz resonator included in a soundproofing device according to a first embodiment of the present disclosure;

FIG. 5 is a cross-sectional view of the Helmholtz resonator taken along a line A-A shown in FIG. 4;

FIG. 6 is a view of a soundproof cover seen from the side of a sound source member shown in FIG. 5;

FIG. 7 is a graph used to explain an advantageous effect of improving the soundproofing performance due to an increase in the air column resonance frequency caused by the installation of partition walls;

FIG. 8 is a schematic diagram used to explain the configuration of a Helmholtz resonator according to a first modification example with respect to the first embodiment of the present disclosure;

FIG. 9 is a schematic diagram used to explain the configuration of a Helmholtz resonator according to a second modification example with respect to the first embodiment of the present disclosure;

FIG. 10 is a cross-sectional view of a Helmholtz resonator included in a soundproofing device according to a second embodiment of the present disclosure;

FIG. 11 is a view of the soundproof cover seen from the side of the sound source member shown in FIG. 10;

FIG. 12 is a cross-sectional view of a Helmholtz resonator included in a soundproofing device according to a third embodiment of the present disclosure;

FIG. 13 is a view of the soundproof cover seen from the side of the sound source member shown in FIG. 12;

FIG. 14A is a graph used to explain an advantageous effect of installing a plurality of partition walls at unequal intervals;

FIG. 14B is a graph used to explain an advantageous effect of installing a plurality of partition walls at unequal intervals;

FIG. 15 is a cross-sectional view of a Helmholtz resonator included in a soundproofing device according to a fourth embodiment of the present disclosure;

FIG. 16 is a cross-sectional view of a Helmholtz resonator included in a soundproofing device according to a fifth embodiment of the present disclosure;

FIG. 17 is a cross-sectional view that schematically illustrates the configuration of another Helmholtz resonator according to the present disclosure;

FIG. 18 is a cross-sectional view that schematically illustrates the configuration of still another Helmholtz resonator according to the present disclosure;

FIG. 19 is a cross-sectional view that schematically illustrates the configuration of yet another Helmholtz resonator according to the present disclosure;

FIG. 20 is a cross-sectional view that schematically illustrates the configuration of still another Helmholtz resonator according to the present disclosure;

FIG. 21 is a cross-sectional view that schematically illustrates the configuration of yet another Helmholtz resonator according to the present disclosure;

FIG. 22 is a cross-sectional view that schematically illustrates the configuration of still another Helmholtz resonator according to the present disclosure;

FIG. 23 is a cross-sectional view that schematically illustrates the configuration of yet another Helmholtz resonator according to the present disclosure;

FIG. 24 is a cross-sectional view that schematically illustrates the configuration of still another Helmholtz resonator according to the present disclosure; and

FIG. 25 is a cross-sectional view that schematically illustrates the configuration of yet another Helmholtz resonator according to the present disclosure.

### DETAILED DESCRIPTION

In the following, embodiments of the present disclosure will be described with reference to the accompanying drawings. However, the same components in the drawings are denoted by the same reference numerals, and redundant descriptions thereof are omitted or simplified. Moreover, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically. Furthermore, structures or the like that are described in conjunction with the following embodiments are not necessarily essential to the present disclosure unless explicitly shown otherwise, or unless the present disclosure is explicitly specified by the structures or the like theoretically.

### [Soundproofing Principle of Helmholtz Resonator Used as Premise]

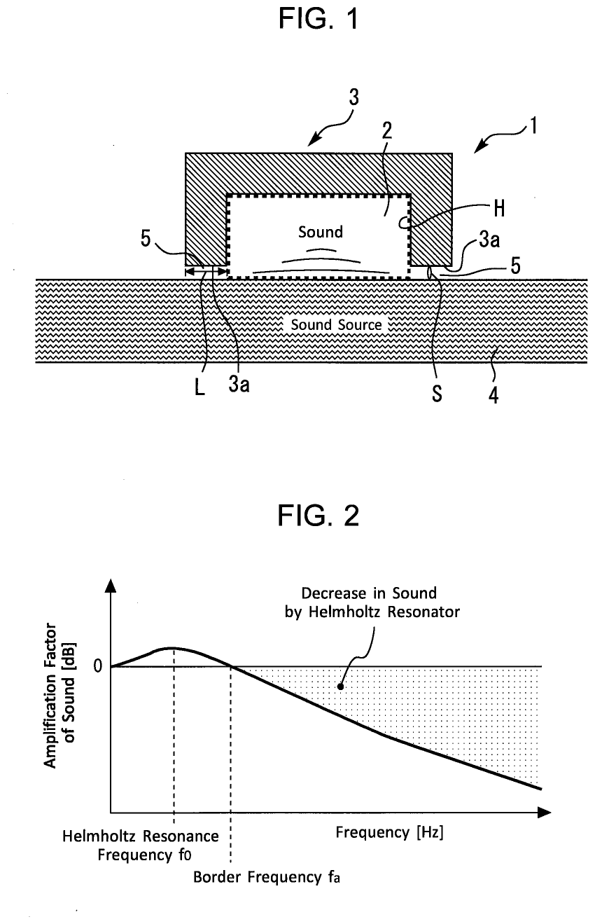

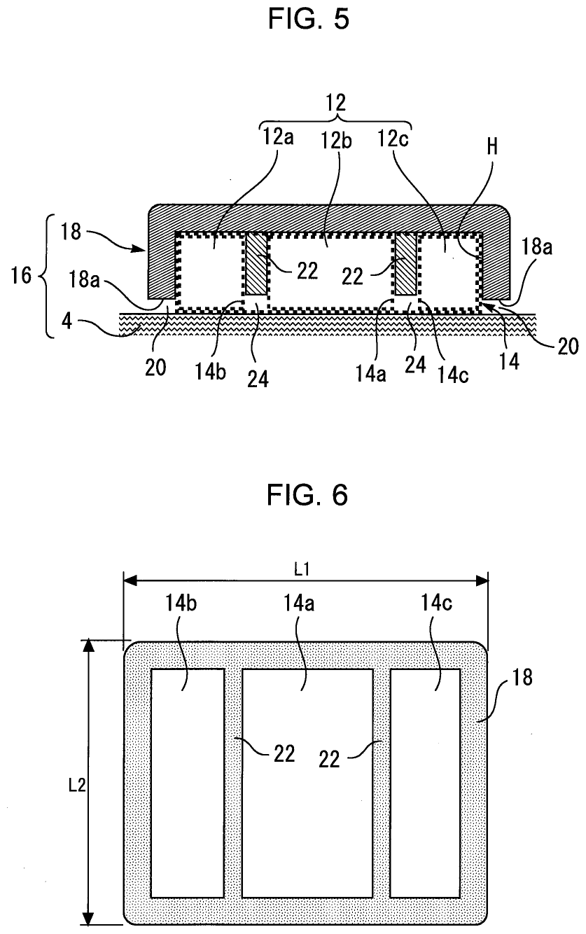

FIG. 1 is a cross-sectional view that schematically illustrates an example of a shape of a Helmholtz resonator using a soundproofing principle used as a premise in a soundproofing device according to the present disclosure. It should be noted that a chamber specified by a broken line frame in FIG. 1 corresponds to a Helmholtz resonance chamber H of the Helmholtz resonator using this soundproofing principle. This also applies to each example of configurations in FIG. 5 and subsequent figures.

A Helmholtz resonator 1 shown in FIG. 1 has a Helmholtz resonance chamber (hereinafter, referred to simply as “resonance chamber”) 2 corresponding to an example of the Helmholtz resonance chamber H. The Helmholtz resonator 1 uses a soundproof cover 3 and a sound source member 4 as a wall forming the resonance chamber 2. That is to say, in the Helmholtz resonator 1, a part of the wall forming the resonance chamber 2 is configured by the sound source member 4. In addition, the Helmholtz resonator 1 has an opening 5 for causing a part of the resonance chamber 2 to communicate with the outside. It should be noted that, instead of a part of the wall forming the resonance chamber 2, the whole of the wall may be configured by a sound source member.

To be more specific, in the example shown in FIG. 1, it is assumed that the soundproof cover 3 has a rectangular parallelepiped shape with an open bottom portion facing the sound source member 4. Also, in this example, the opening 5 is formed by using a gap between an end portion 3a of the soundproof cover 3 and the sound source member 4. In order to place the soundproof cover 3 on (or over) the sound source member 4, a part of the end portion 3a may be extended so as to be in contact with the sound source member 4 (for example, see an example shown in FIG. 4 described below)). Alternatively, the soundproof cover 3 may be supported by a supporting member (not shown) such that the entire end portion 3a of the soundproof cover 3 is separated from the sound source member 4.

A resonance frequency (Helmholtz resonance frequency) f₀ of the Helmholtz resonator 1 is determined by the following Equation (1).

c: Speed of sound (m/s)
V: Volume of the Helmholtz resonator (resonance chamber) (m³)
L: Length of the opening (m)
S: Area of the opening (i.e., area of the opening when viewed from a direction perpendicular to the direction of the length L) (m²)
δ1: Open end correction coefficient (which is a correction value determined according to the shape of the Helmholtz resonator and also experimentally determined)

$${f}_{0} = \frac{c}{2 π} \sqrt{\frac{S}{V ( L + δ 1 )}} \qquad ( 1 )$$

By appropriately determining the dimensions of each part of the Helmholtz resonator 1 (i.e., the volume V, the area S and the length L in the Equation (1)), a Helmholtz resonance chamber H having a desired Helmholtz resonance frequency f₀ can be obtained.

FIG. 2 is a graph used to explain a soundproofing effect by the Helmholtz resonator 1 shown in FIG. 1. FIG. 2 shows a relationship between the input frequency of the Helmholtz resonator 1 (i.e., the frequency (Hz) of a radiated sound from the sound source member 4) and the amplification factor (dB) of the radiated sound. In the Helmholtz resonator 1, resonance of the radiated sound inputted to the resonance chamber 2 occurs at the resonance frequency f₀. Because of this, as shown in FIG. 2, the radiated sound is amplified in a frequency band around the resonance frequency f₀ at which the amplification factor has a peak. On the other hand, in a high frequency band higher than this frequency band (i.e., a high frequency band higher than a border frequency fₐ shown in FIG. 2), the amplification factor is lower than 0 dB, and the higher the frequency of a radiated sound inputted is, the lower the amplification factor is. This is because, in the high frequency band described above, the radiated sound inside the Helmholtz resonator 1 (i.e., inside the resonance chamber 2) becomes difficult to propagate to the outside of the Helmholtz resonator 1 due to the inertial effect of the air in the opening 5.

Therefore, according to the Helmholtz resonator 1 based on the soundproofing principle described above, the soundproofing effect can be obtained in a wider frequency band than that of a general Helmholtz resonator (for example, as disclosed in JP 2001-041020 A, a Helmholtz resonator having a configuration in which a sound source member is not used as a wall forming a Helmholtz resonance chamber) in which the soundproofing effect can be obtained only in a narrow frequency band around a resonance frequency. It should be noted that the details of the soundproofing principle that the present disclosure is premised on are disclosed in WO 2012/144078 A1.

### (Supplementary Explanation on Helmholtz Resonance Chamber H)

As described above, the “Helmholtz resonance chamber H” of a Helmholtz resonator according to the present soundproofing principle is a chamber which is formed by a wall whose at least a part is a sound source member, and which can communicate with the outside through a first opening formed in the wall. Also, according to the Helmholtz resonator having this kind of Helmholtz resonance chamber H, as described with reference to FIG. 2, a soundproofing effect (sound pressure reduction effect) can be obtained in a frequency band located on the higher frequency side than the Helmholtz resonance frequency f₀ determined by Equation (1). Therefore, it can be said that the Helmholtz resonance chamber H using the soundproofing principle has a soundproofing effect in a frequency band higher than the Helmholtz resonance frequency f₀ (more specifically, in a high frequency band higher than the border frequency fₐ).

### (Supplementary Explanation on Sound Source Member)

The “sound source member” according to the present disclosure is a member that radiates sound and, more specifically, a member that radiates, into the air as sound, vibration transmitted from a sound generating source (i.e., a compulsory sound source). In an example of an internal combustion engine, a combustion chamber in which combustion is performed corresponds to an example of the compulsory sound source. Also, a member, such as a cylinder head or a cylinder block that radiates vibration from the combustion chamber into the air as sound, corresponds to an example of the “sound source member”. Moreover, in an example of a transmission, gears or an oil pump arranged inside the transmission corresponds to another example of the compulsory sound source, and a housing of the transmission corresponds to another example of the “sound source member”. It should be noted that the sound source member is not limited to a device mounted on the vehicle, such as the internal combustion engine or the transmission exemplified here.

Additionally, a portion (for example, a soundproof cover) of the wall forming the Helmholtz resonance chamber H that is other than the sound source member may be arranged for a part of the sound source member similarly to the example shown in FIG. 1. Alternatively, a portion of the wall other than the sound source member may be formed so as to cover the entire sound source member being a part of the wall.

### [Issue due to Air Column Resonance]

In the resonance chamber 2 of the Helmholtz resonator 1 shown in FIG. 1, when the frequency of a radiated sound from the sound source member 4 becomes equal to the resonance frequency of an air column (i.e., air in the resonance chamber 2), air column resonance occurs. To be more specific, the radiated sound from the sound source member 4 propagates three-dimensionally in the resonance chamber 2. When an air column having a length D [m] in a specific direction in the Helmholtz resonator 1 is considered, the resonance frequency f₁ [Hz] of the air column (air column resonance frequency) is determined by the following Equation (2).

c: Speed of sound (m/s)
δ2: Open end correction coefficient (which is an experimentally determined value)

$${f}_{1} = \frac{c}{2 ( D + δ2 )} \qquad ( 2 )$$

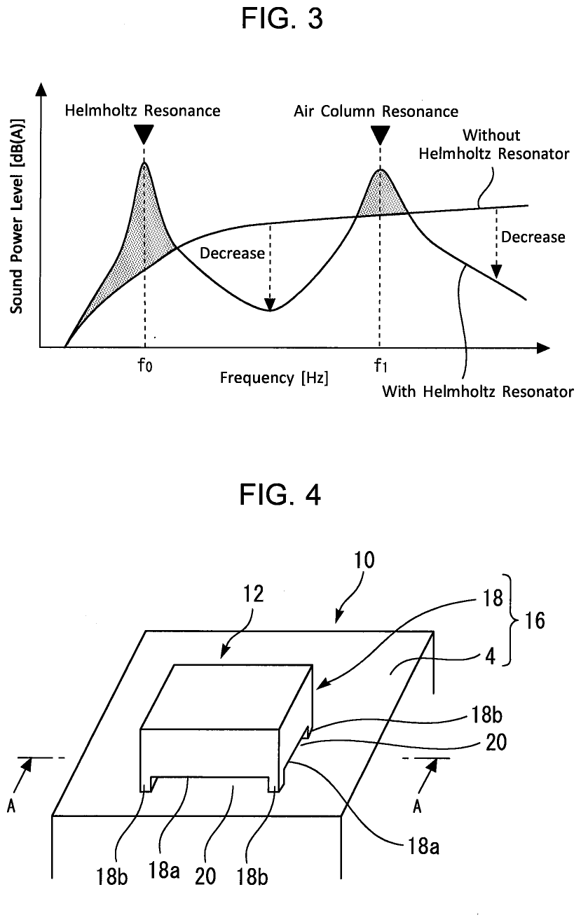

FIG. 3 is a graph used to explain an issue caused by the air column resonance, and shows a relationship between sound power level [dB(A)] and frequency [Hz]. In more detail, in FIG. 3, the sound power level of the radiated sound from the sound source member 4 is compared between an example without the Helmholtz resonator 1 shown in FIG. 1 and an example with the Helmholtz resonator 1.

Due to the effect of the Helmholtz resonator 1 already described with reference to FIG. 2, the sound power level is amplified at and near the Helmholtz resonance frequency f₀, as shown in FIG. 3. However, the sound power level is reduced in a high frequency band higher than the resonance frequency f₀. On the other hand, due to the effect of the air column resonance in the resonance chamber 2, the sound power level increases in a frequency band around the air column resonance frequency f₁, for example, as shown in FIG. 3. As a result, the above-described soundproofing effect by the Helmholtz resonator 1 is lowered. It should be noted that, though omitted in FIG. 3, peaks of the sound power level caused by the air column resonance occur repeatedly not only at the air column resonance frequency f₁ but also at higher frequencies than the air column resonance frequency f₁ (more specifically, at respective frequencies which are natural multiples of the air column resonance frequency f₁). In addition, FIG. 3 exemplarily shows the effect of the air column resonance in a specific direction in the resonance chamber 2.

In order to obtain a high soundproofing effect by using the Helmholtz resonator according to the principle shown in FIG. 1, it is desired to be able to reduce a decrease in the soundproofing effect caused by the air column resonance described above. In view of this kind of issue, soundproofing devices according to the following embodiments are provided.

### 1. First Embodiment

A first embodiment according to the present disclosure and its modification examples will be described with reference to FIGS. 4 to 9.

### 1-1. Configuration of Helmholtz Resonator

FIG. 4 is a perspective view that schematically illustrates the configuration of a Helmholtz resonator 12 included in a soundproofing device 10 according to the first embodiment of the present disclosure. FIG. 5 is a cross-sectional view of the Helmholtz resonator 12 taken along a line A-A shown in FIG. 4. FIG. 6 is a view of a soundproof cover 18 seen from the side of the sound source member 4 shown in FIG. 5.

The Helmholtz resonator 12 shown in FIG. 4 uses the sound source member 4 together with the soundproof cover 18 as a wall 16 forming a Helmholtz resonance chamber 14 corresponding to an example of the Helmholtz resonance chamber H. That is to say, in the Helmholtz resonator 12, similarly to the Helmholtz resonator 1, a part of the wall 16 forming the resonance chamber 14 is configured by the sound source member 4. In addition, the Helmholtz resonator 12 has a first opening 20. The first opening 20 is formed in the wall 16 so as to cause the resonance chamber 14 to communicate with the outside.

To be more specific, the soundproof cover 18 has a rectangular parallelepiped shape with an open bottom portion facing the sound source member 4, similarly to the soundproof cover 3 as an example. Also, the first opening 20 is formed by using a gap between an end portion 18a of the soundproof cover 18 and the sound source member 4. In order to place the soundproof cover 18 on the sound source member 4, the soundproof cover 18 includes, as an example, four leg portions 18b formed at four corners of the end portion 18a, respectively. These leg portions 18b are attached to the sound source member by bolts (not shown) as an example. However, any other attachment manner (e.g., bonding) may be used.

As the material of the soundproof cover 18, for example, a metal material (such as iron, aluminum, stainless steel or magnesium), a plastic material, or a porous material (such as fiber or foam) can be used. In addition, as the material of the soundproof cover 18, for example, a single-layer material or a multilayer material made of the material exemplified here may be used. The same applies to soundproof covers in the other embodiments.

Furthermore, as shown in FIGS. 5 and 6, the Helmholtz resonator 12 includes two partition walls 22 in the shape of a flat plate formed to divide the Helmholtz resonance chamber 14 into a plurality of regions (as an example, three regions 14a, 14b, and 14c). In more detail, the two partition walls 22 are formed so as to extend from the wall 16 into the Helmholtz resonance chamber 14. According to the present embodiment, each of the two partition walls 22 is formed so as to extend from an inner wall of the soundproof cover 18 facing the sound source member 4 toward the side of the sound source member 4. Also, as shown in FIG. 6, the two partition walls 22 extend so as to connect between inner walls of two mutually opposed side surfaces of the four side surfaces of the soundproof cover 18 having the first opening 20. Moreover, a second opening 24 is formed between each of the partition walls 22 and the sound source member 4. In other words, the second opening 24 is formed in each of the partition walls 22 so as to cause the three regions 14a to 14c to communicate with each other.

Additionally, in the shape example shown in FIG. 6, with regard to the width of the four side surfaces of the soundproof cover 18, the width L1 of the two side surfaces in the horizontal direction of the drawing is longer than the width L2 of the two side surfaces in the vertical direction of the drawing. According to the present embodiment, the two partition walls 22 are formed so as to extend in a direction perpendicular to the direction of the width L1 when viewed from the side of the sound source member 4. It should be noted that the direction of the width L1 corresponds to an example of the “first direction” according to the present disclosure, and the direction of the width L2 corresponds to an example of the “second direction” according to the present disclosure.

### 1-2. Advantageous Effect

As described so far, the Helmholtz resonator 12 according to the first embodiment includes two partition walls 22 formed to divide the Helmholtz resonance chamber 14 into three regions 14a to 14c. Also, the three regions 14a to 14c communicate with each other through the second openings 24. The Helmholtz resonator 12 thereby functions as three Helmholtz resonators 12a to 12c in which each of the three regions 14a to 14c is a Helmholtz resonance chamber and these Helmholtz resonance chambers communicate with each other. As a result, not only the individual Helmholtz resonators 12a to 12c achieve the soundproofing effect according to the soundproofing principle shown in FIG. 1, but also the following effect can be achieved.

### 1-2-1. Increase in Air Column Resonance Frequency

First, according to the Helmholtz resonator 12 of the first embodiment, the following effect of improving the soundproofing performance (sound pressure reduction effect) can be achieved. That is to say, the installation of the partition walls 22 shortens the length D of the air column that extends in the direction of the width L1 shown in FIG. 6. From Equation (2) described above, the shortening of the length D of the air column means that the air column resonance frequency f₁ becomes higher. As just described, by dividing the Helmholtz resonance chamber 14 using the partition walls 22, when the entire Helmholtz resonator 12 is regarded as one Helmholtz resonator, the frequency f₁ of the air column resonance that occurs in a specific direction (in the example shown in FIG. 6, the direction of the width L1) can be increased.

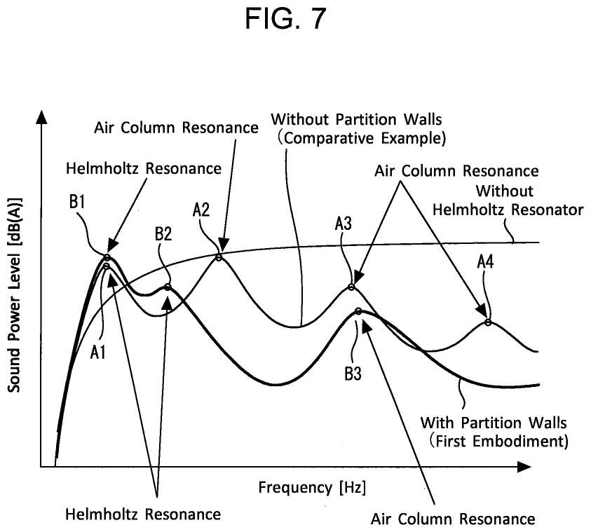

FIG. 7 is a graph used to explain an advantageous effect of improving the soundproofing performance due to an increase in the air column resonance frequency caused by the installation of the partition walls 22. In FIG. 7, a Helmholtz resonator (hereinafter referred to as “Helmholtz resonator A” for convenience) in an example without partition walls (comparative example) corresponds to the Helmholtz resonator 12 from which the two partition walls 22 are removed. A peak A1 of the sound power level in this comparative example is associated with the Helmholtz resonance by the Helmholtz resonator A according to the soundproofing principle shown in FIG. 1. In addition, peaks A2, A3, and A4 correspond to three peaks located on the lower-frequency side among a plurality of peaks associated with the air column resonance in the Helmholtz resonator A (more specifically, the air column resonance in the direction of the width L1 shown in FIG. 6).

On the other hand, in an example with the partition walls in FIG. 7 (i.e., in the example of the Helmholtz resonator 12 according to the first embodiment), peaks B1 and B2 correspond to two peaks associated with a Helmholtz resonance by the Helmholtz resonators 12a to 12c obtained by being divided by the partition walls 22. In more detail, the peak B1 is associated with the two outer Helmholtz resonators 12b and 12c and the peak B2 is associated with the inner Helmholtz resonator 12a. Moreover, a peak B3 corresponds to a peak having the lowest frequency among a plurality of peaks associated with the air column resonance in the Helmholtz resonator 12 (more specifically, the air column resonance in the direction of the width L1 shown in FIG. 6).

As exemplarily shown in FIG. 7, increasing the air column resonance frequency by the installation of the partition walls 22 means that the frequency at which a peak of the sound power level caused by the air column resonance occurs is shifted to the high frequency side as compared with the comparative example. As a result, one or more peaks of the sound power level caused by the air column resonance in the low frequency band, such as the peak A2 shown in FIG. 7, can be eliminated. As just described, the installation of the partition walls 22 can improve the soundproofing performance (in other words, reduce a decrease in the soundproofing effect caused by the air column resonance). Furthermore, according to the present technique for increasing the air column resonance frequency in this manner, by properly selecting the shape of one or more partition walls, it is possible to take soundproofing measures for shifting one or more peaks of the sound power level caused by the air column resonance to a frequency band higher than the human audible range.

Additionally, as already described, the radiated sound from the sound source member 4 propagates three-dimensionally in the Helmholtz resonance chamber H. As can be seen from Equation (2), when the length D of the air column is large, the air column resonance frequency f₁ is low. On the other hand, as shown in FIG. 2, the higher the frequency is, the greater the soundproofing effect by the Helmholtz resonance becomes. Because of this, it is desirable to lower the Helmholtz resonance frequency f₀ in order to achieve the soundproofing effect in a wide frequency band. However, if an air column in a specific direction in the Helmholtz resonance chamber H is long, the peak A2 due to the air column resonance may approach the peak A1 due to the Helmholtz resonance as illustrated in FIG. 7. As a result, the soundproofing effect is easily prevented in a frequency band in which the soundproofing effect by the Helmholtz resonance is relatively low since the frequency is close to the Helmholtz resonance frequency f₀ (in the example shown in FIG. 7, in a frequency band near the peak A2).

In view of the above, according to the present embodiment, each of the two partition walls 22 is formed so as to extend in a direction perpendicular to the direction of the width L1 in which the length D of the air column becomes longer in the Helmholtz resonator 12 (in other words, so as to divide the Helmholtz resonance chamber 14 in a plane perpendicular to the direction of the width L1). As a result, since the length D of the air column in the direction of the relatively long width L1, which is the longest in the example of the Helmholtz resonator 12, can be shortened, the air column resonance frequency in the direction of the width L1 can be increased. As a result, it is possible to eliminate an air column resonance that causes one or more peaks of the sound power level in the low frequency band (for example, the peak A2 in FIG. 7). It should be noted that, instead of the example described above, only one of a plurality of partition walls may be formed so as to extend in a direction perpendicular to the “first direction” according to the present disclosure.

### 1-2-2. Double Vibration Proofing Effect

Furthermore, according to the Helmholtz resonator 12 of the first embodiment, not only the above-described viewpoint of increasing the air column resonance frequency but also the following advantageous effect of improvement of the soundproofing performance (sound pressure reduction effect) based on the viewpoint of double vibration proofing (double soundproofing) can be achieved. That is to say, in the example of the Helmholtz resonator 12 according to the first embodiment, the double vibration proofing effect mentioned here is achieved with respect to the propagation of the radiated sound in the direction of the width L1 shown in FIG. 6. In more detail, when considered about the direction of the width L1, even if a part of the sound radiated from the sound source member 4 into the inner Helmholtz resonator 12a propagates to the outer side of the Helmholtz resonator 12a, the propagated sound can be absorbed by the outer Helmholtz resonator 12b or 12c. In addition, this kind of double vibration proofing effect can be similarly achieved even when sound propagates from the outer Helmholtz resonator 12b or 12c to the inner Helmholtz resonator 12a, contrary to the above.

Modification Examples with Respect to First Embodiment

### 1-3-1. First Modification Example

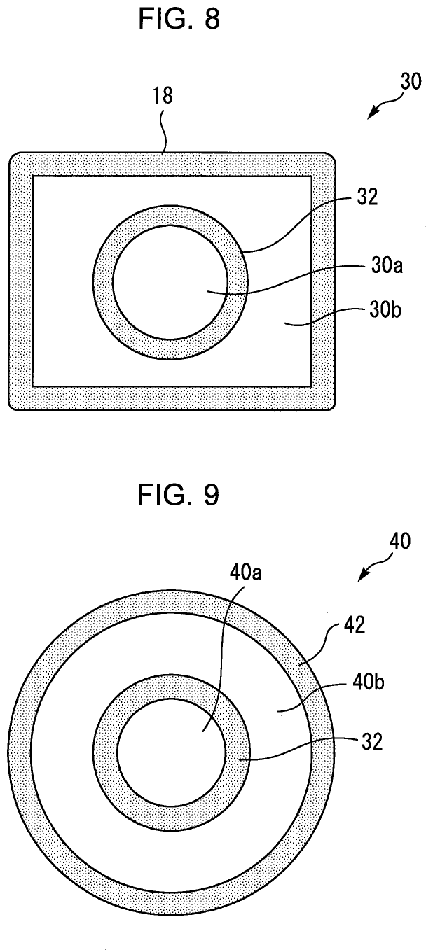

FIG. 8 is a schematic diagram used to explain the configuration of a Helmholtz resonator 30 according to a first modification example with respect to the first embodiment of the present disclosure. FIG. 8 is a view of the soundproof cover 18 seen from the direction of the sound source member 4, similarly to FIG. 6. The Helmholtz resonator 30 shown in FIG. 8 is different from the Helmholtz resonator 12 according to the first embodiment in that the shape of a partition wall 32 is different from that of the partition walls 22. With regard to the cross-sectional shape shown in FIG. 5, the Helmholtz resonator 30 is the same as the Helmholtz resonator 12.

As shown in FIG. 8, the partition wall 32 has a circular shape when viewed from the side of the sound source member 4. That is to say, the partition wall 32 is formed in a cylindrical shape that extends toward the sound source member 4 from the inner wall of the soundproof cover 18 facing the sound source member 4. The Helmholtz resonance chamber H of the Helmholtz resonator 30 is divided into two regions by the partition wall 32 formed in this manner. The two divided regions communicate with each other through a second opening (not shown). As a result, the Helmholtz resonator 30 functions as two Helmholtz resonators 30a and 30b in which the two regions are the respective Helmholtz resonance chambers H and these Helmholtz resonance chambers H communicate with each other. More specifically, the Helmholtz resonator 30a is located on the inner circumferential side of the partition wall 32, and the Helmholtz resonator 30b is located on the outer circumferential side of the partition wall 32.

According to the Helmholtz resonator 30 so far, unlike the Helmholtz resonator 12 shown in FIG. 6, the periphery of the inner Helmholtz resonator 30a is wholly covered by the outer Helmholtz resonator 30b. That is to say, a Helmholtz resonator having a double structure by the inner Helmholtz resonator 30a and the outer Helmholtz resonator 30b is obtained. As a result, the double vibration proofing effect can be effectively enhanced as compared with the Helmholtz resonator 12 according to the first embodiment.

It should be noted that the Helmholtz resonance chamber H of the inner Helmholtz resonator 30a corresponds to an example of the “first region” according to the present disclosure, and the Helmholtz resonance chamber H of the outer Helmholtz resonator 30b corresponds to an example of the “one or a plurality of second regions” according to the present disclosure. The shape of the inner wall for realizing this kind of double structure may be any shape other than the circular shape of the partition wall 32 (for example, a polygonal shape). This also applies to the following second modification example.

### 1-3-2. Second Modification Example

FIG. 9 is a schematic diagram used to explain the configuration of a Helmholtz resonator 40 according to a second modification example with respect to the first embodiment of the present disclosure. The Helmholtz resonator 40 shown in FIG. 9 includes a soundproof cover 42 instead of the soundproof cover 18. FIG. 9 is a view of the soundproof cover 42 seen from the same direction as FIG. 8.

The Helmholtz resonator 40 is common to the Helmholtz resonator 30 shown in FIG. 8 in that the Helmholtz resonator 40 includes the partition wall 32, and is different from the Helmholtz resonator 30 in the shape of the soundproof cover. As shown in FIG. 9, the soundproof cover 42 has a circular shape when viewed from the side of the sound source member 4. That is to say, the soundproof cover 42 is formed in a cylindrical shape that is open at a surface on the side of the sound source member 4. Similarly to the Helmholtz resonator 30, the Helmholtz resonator 40 also functions as a Helmholtz resonator 40a having a Helmholtz resonance chamber H located on the inner circumference side of the partition wall 32 and a Helmholtz resonator 40b having a Helmholtz resonance chamber H located on the outer circumference side of the partition wall 32.

The Helmholtz resonator 40 so far can provide a Helmholtz resonator having a double structure in which the outer Helmholtz resonator 40b wholly covers the periphery of the inner Helmholtz resonator 40a. Even with this kind of configuration, the double vibration proofing effect can be effectively enhanced as compared with the Helmholtz resonator 12 according to the first embodiment.

### 2. Second Embodiment

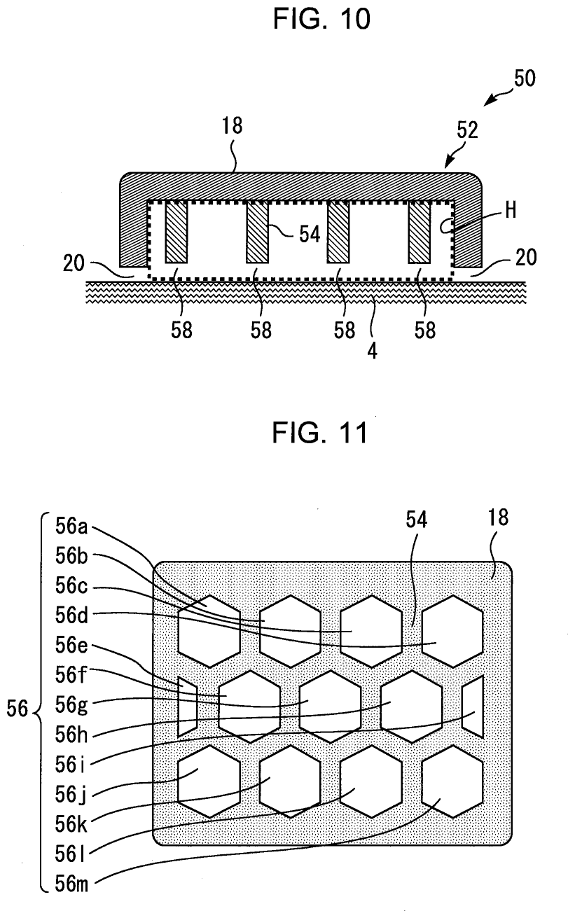

Next, a second embodiment according to the present disclosure will be described with reference to FIGS. 10 and 11. FIG. 10 is a cross-sectional view of a Helmholtz resonator 52 included in a soundproofing device 50 according to the second embodiment of the present disclosure. FIG. 11 is a view of the soundproof cover 18 seen from the side of the sound source member 4 shown in FIG. 10. The Helmholtz resonator 52 according to the second embodiment is different from the Helmholtz resonator 12 according to the first embodiment in the shape and number of the partition walls.

Specifically, the Helmholtz resonator 52 includes a partition wall 54. As shown in FIG. 11, the partition wall 54 has a honeycomb cross-sectional shape when viewed from the side of the sound source member 4. As shown in FIG. 11, a Helmholtz resonance chamber 56 corresponding to another example of the Helmholtz resonance chamber H is divided into a plurality of regions 56a to 56m by the partition wall 54 formed in a honeycomb shape. Each of the plurality of regions 56a to 56m functions as a Helmholtz resonance chamber H. Also, a second opening 58 is formed between the partition wall 54 and the sound source member 4. In other words, the second opening 58 is formed in the partition wall 54 so as to cause the plurality of regions 56a to 56m to communicate with each other.

According to the Helmholtz resonator 52 described so far, since the Helmholtz resonance chamber 56 is finely divided by the partition wall 54, the length D of the air column in each direction in individually divided Helmholtz resonance chambers H can be effectively shortened. As a result, the air column resonance frequency can be effectively shifted to the high frequency side. Because of this, the soundproofing performance can be improved. In other words, a decrease in the soundproofing effect caused by the air column resonance can be reduced.

The use of the honeycomb-shaped partition wall 54 divides the Helmholtz resonance chamber 56 more finely than the Helmholtz resonance chamber 14 according to the first embodiment. As a result, two or more multiple vibration proofing effect can be achieved in the individual Helmholtz resonance chambers H adjacent to each other with the partition wall 54 interposed therebetween. Because of this, the soundproofing performance of the soundproofing device 50 can be effectively enhanced.

To be more specific, in this honeycomb-shaped example, a double structure can also be achieved in which the three central regions (Helmholtz resonance chambers H) 56f, 56g and 56h are wholly covered by the outer region (Helmholtz resonance chamber H) 56a and the like, in the same manner as in the examples shown in FIGS. 8 and 9. In this respect, the double vibration proofing effect can be effectively enhanced. It should be noted that, in the example shown in FIG. 11, the three central regions 56f, 56g and 56h correspond to another example of the “first region” according to the present disclosure. Also, when the region 56f is regarded as the first region, the regions 56a, 56b, 56g, 56k, 56j and 56e correspond to another example of the “one or a plurality of second regions” according to the present disclosure. Since this also applies to other regions 56g and 56h when each of them is regarded as the first region, the description thereof is omitted.

### 3. Third Embodiment

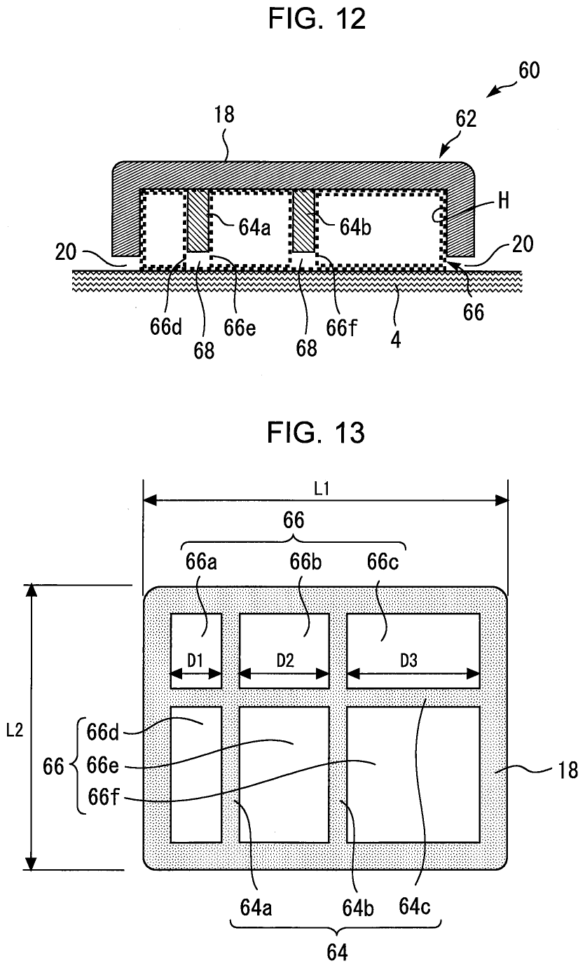

Next, a third embodiment according to the present disclosure will be described with reference to FIGS. 12 and 13. FIG. 12 is a cross-sectional view of a Helmholtz resonator 62 included in a soundproofing device 60 according to the third embodiment of the present disclosure. FIG. 13 is a view of the soundproof cover 18 seen from the side of the sound source member 4 shown in FIG. 12. The Helmholtz resonator 62 of the third embodiment is different from the Helmholtz resonator 12 according to the first embodiment in the interval, number and installation location of the partition walls.

Specifically, the Helmholtz resonator 62 includes three partition walls 64 (64a to 64c) formed in a flat plate shape. Of the three partition walls 64, two partition walls 64a and 64b are formed so as to extend in a direction perpendicular to the direction of the width L1 of the soundproof cover 18, similarly to the partition walls 22 shown in FIG. 6. However, these partition walls 64a and 64b are different from the partition walls 22 in the installation interval. As an example, as shown in FIG. 13, a distance D1 between the partition wall 64a and an inner wall of the soundproof cover 18 facing this partition wall 64a is shorter than a distance D2 between the partition wall 64a and the partition wall 64b. In addition, the distance D2 is shorter than a distance D3 between the partition wall 64b and an inner wall of the soundproof cover 18 facing the partition wall 64b.

Furthermore, the remaining partition wall 64c is formed so as to extend in a direction perpendicular to the partition walls 64a and 64b when viewed from the side of the sound source member 4. By additionally including the partition wall 64c, the Helmholtz resonance chamber 66 can be divided into a plurality of finer regions 66a to 66f as compared with the first embodiment. Each of the plurality of regions 66a to 66f functions as a Helmholtz resonance chamber H. Also, a second opening 68 is formed between the partition wall 64 and the sound source member 4. In other words, the second opening 68 is formed in the partition wall 64 so as to cause the plurality of regions 66a to 66f to communicate with each other.

According to the Helmholtz resonator 62 described so far, similarly to the Helmholtz resonator 12 according to the first embodiment, the advantageous effect of increasing the air column resonance frequency and the double vibration proofing effect can be achieved. On that basis, according to the Helmholtz resonator 62, the following advantageous effect can be achieved.

(Advantageous Effect Associated with Installation of Partition Walls at Unequal Intervals)

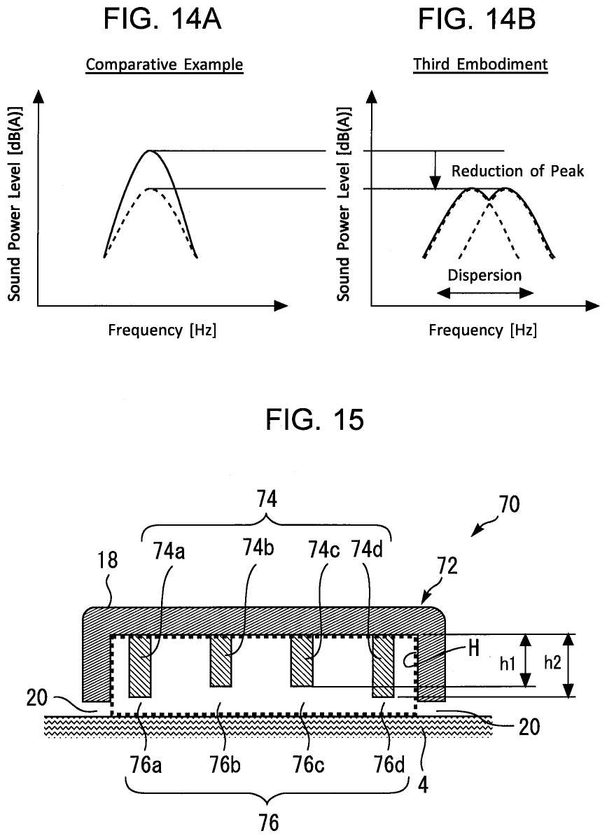

FIGS. 14A and 14B are graphs used to explain the advantageous effect of installing the partition wall 64a and the partition wall 64b at unequal intervals. FIG. 14A corresponds to a comparative example referred to for comparison with the third embodiment. This comparative example refers to an example in which two Helmholtz resonance chambers H of the same size are included as in the example of the Helmholtz resonance chambers 14b and 14c shown in FIG. 6. A waveform shown by a broken line in FIG. 14A shows a peak of the sound power level caused by the air column resonance in each Helmholtz resonance chamber H in this comparative example. Since these two Helmholtz resonance chambers H have the same size, the peak of the sound power level caused by the air column resonance occurs at the same air column resonance frequency. As a result, as shown by a solid line in this figure, the peak is amplified by synthesizing two broken line waveforms.

On the other hand, FIG. 14B corresponds to the third embodiment. In the Helmholtz resonator 62, the partition wall 64a and the partition wall 64b are arranged at unequal intervals as described above. Because of this, when, for example, the region 66d and the region 66f are compared with each other, the air column resonance frequencies of the region 66d and the region 66f are different from each other (more specifically, with regard to the air column resonance in the direction of the width L1 in FIG. 13). As a result, the frequencies at which peaks of the sound power level of them occur become different from each other, as shown by waveforms indicated by broken lines in FIG. 14B. Because of this, the peak can be reduced (i.e., the amplification of the peak can be reduced) as shown by a waveform indicated by a solid line in this figure.

As described above, by arranging the partition walls 64a and 64b at unequal intervals, the frequencies of the air column resonances in a direction that should be improved (in the example shown in FIG. 13, in the direction of the width L1) are dispersed. By dispersing the air column resonance frequencies, the effect of reducing the sound power level (soundproofing effect) can be improved. It should be noted that three or more partition walls may be used instead of the example of the Helmholtz resonator 62 in order to disperse the air column resonance frequencies by installing the partition walls at unequal intervals.

### 4. Fourth Embodiment

Next, a fourth embodiment according to the present disclosure will be described with reference to FIG. 15. FIG. 15 is a cross-sectional view of a Helmholtz resonator 72 included in a soundproofing device 70 according to the fourth embodiment of the present disclosure. The Helmholtz resonator 72 according to the fourth embodiment is different from the Helmholtz resonator 52 according to the second embodiment in the following points.

That is to say, according to the second embodiment, as shown in FIG. 10, the Helmholtz resonator 52 in which the height of the partition wall 54 (in other words, the size of the second opening 58) is constant regardless of the position is exemplified. On the other hand, the Helmholtz resonator 72 has different heights at the respective portions of a partition wall 74 as shown in FIG. 15. In more detail, in the example shown in FIG. 15, a height h1 of portions 74b and 74c located on the center side in the soundproof cover 18 is lower than a height h2 of portions 74a and 74d adjacent thereto. As a result, a second opening 76 is greater in central portions 76b and 76c than in portions 76a and 76d adjacent thereto.

As exemplarily illustrated in FIG. 15, the height of one or more partition walls used in a Helmholtz resonator according to the present disclosure (i.e., the size of a second opening) may not be constant regardless of the position, and may vary depending on the position. In addition, the height of one or more partition walls (the size of a second opening) may be appropriately changed in order to disperse the air column resonance frequencies as described with reference to FIGS. 14A and 14B.

### 5. Fifth Embodiment

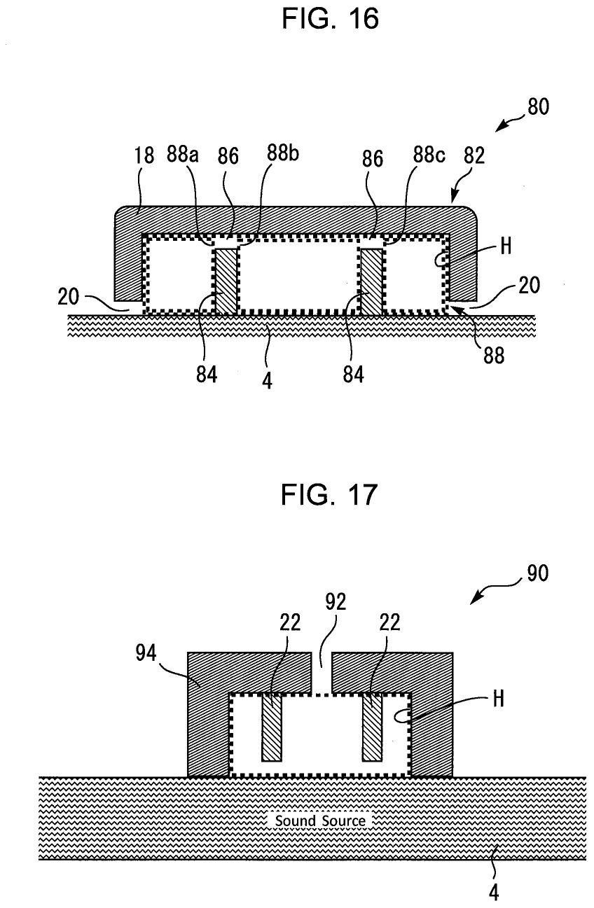

Next, a fifth embodiment according to the present disclosure will be described with reference to FIG. 16. FIG. 16 is a cross-sectional view of a Helmholtz resonator 82 included in a soundproofing device 80 according to the fifth embodiment of the present disclosure. The Helmholtz resonator 82 according to the fifth embodiment is different from the Helmholtz resonator 12 according to the first embodiment in the following points.

That is to say, as shown in FIG. 16, the Helmholtz resonator 82 includes two partition walls 84 formed in a flat plate shape. In contrast to the examples which have been described above, the partition walls 84 are formed so as to protrude not from the soundproof cover 18 but from the sound source member 4 toward the soundproof cover 18. A second opening 86 is formed between each partition wall 84 and the soundproof cover 18. In other words, each of the second openings 86 is formed in the corresponding partition wall 84 so as to cause a Helmholtz resonance chamber 88 corresponding to another example of the Helmholtz resonance chamber H to communicate with three regions 88a to 88c.

As exemplarily illustrated in FIG. 16, one or more partition walls used in the Helmholtz resonator according to the present disclosure may be arranged on a sound source member itself, instead of a portion (for example, the soundproof cover 18) of a wall forming the Helmholtz resonance chamber H that is other than the sound source member. In addition, one or more partition walls may be arranged on both of a “portion other than the sound source member” and the sound source member. Furthermore, an existing rib of a sound source member, for example, may be used as a partition wall.

### 6. Other Embodiments (Other Examples of Basic Shape of Helmholtz Resonator)

In the first to fifth embodiments and the first and second modification examples described above, examples of the Helmholtz resonator 12 and the like are exemplified. The Helmholtz resonator 12 and the like include: the soundproof cover 18 having a rectangular parallelepiped shape (or the soundproof cover 42 having a cylindrical shape) with the open bottom portion facing the sound source member 4; the sound source member 4 configuring one surface of the wall (the wall 16 or the like) of the Helmholtz resonance chamber H; and the first opening 20 formed using the gap between the end portion of the soundproof cover 18 or the like and the sound source member 4. However, other examples of the basic shape of a Helmholtz resonator (for example, the shape of a wall (a soundproof cover and a sound source member), and the position and number of the first opening) to which the present disclosure is applied include examples described below with reference to FIGS. 17 to 25.

It should be noted that, in the individual examples shown in FIGS. 17 to 25, configurations for which explanation is omitted are similar to those of the first to fifth embodiments. In addition, “partition walls” used to divide the Helmholtz resonance chamber H into a plurality of regions in each of the following configurations are similar to the partition walls 22 according to the first embodiment as an example. Therefore, for convenience of description, partition walls of each example are referred to as “partition walls 22” similarly to the first embodiment. Moreover, in each of the following examples, a “second opening” is formed by using a gap between the partition walls 22 and each sound source member.

FIG. 17 is a cross-sectional view that schematically illustrates the configuration of another Helmholtz resonator 90 according to the present disclosure. The Helmholtz resonator 90 is different from the Helmholtz resonator 12 according to the first embodiment in the position of the first opening. That is to say, in this example, a first opening 92 is formed in one surface of a soundproof cover 94 facing the sound source member 4.

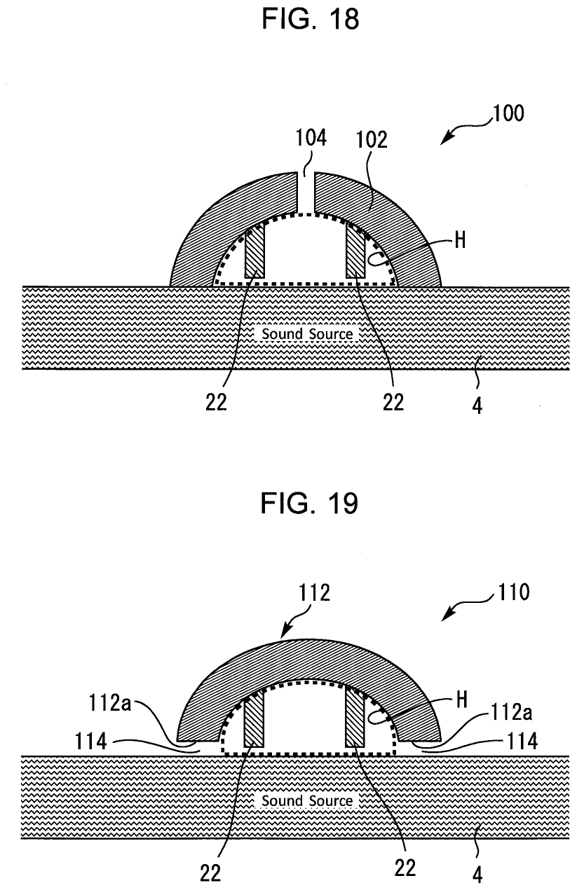

FIG. 18 is a cross-sectional view that schematically illustrates the configuration of still another Helmholtz resonator 100 according to the present disclosure. The Helmholtz resonator 100 is different from the Helmholtz resonator 12 according to the first embodiment in the shape of the soundproof cover and the position of the first opening. That is to say, in this example, a soundproof cover 102 has a hemispherical shape opened on the side of the sound source member 4. A first opening 104 is formed in a portion of the soundproof cover 102 facing the sound source member 4.

FIG. 19 is a cross-sectional view that schematically illustrates the configuration of yet another Helmholtz resonator 110 according to the present disclosure. The Helmholtz resonator 110 includes a hemispherical soundproof cover 112, similar to the example shown in FIG. 18. In this example, a first opening 114 is formed by using a gap between an end portion 112a of the soundproof cover 112 and the sound source member 4, similarly to the first embodiment.

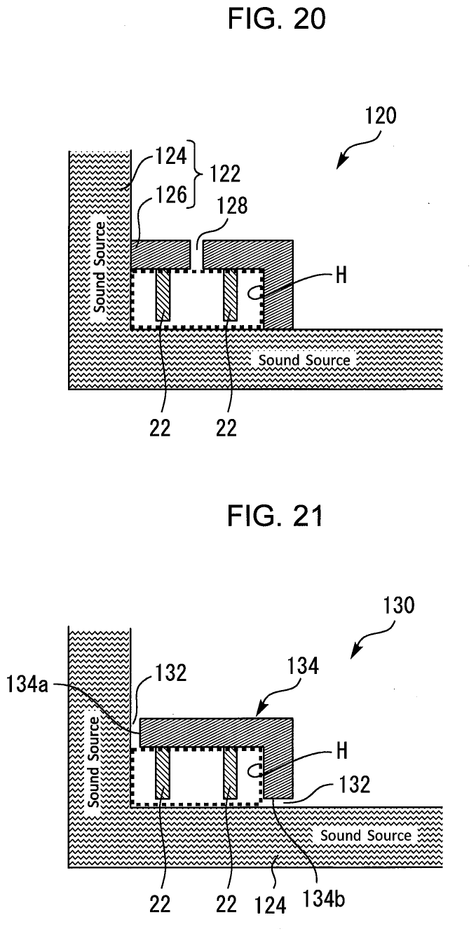

FIG. 20 is a cross-sectional view that schematically illustrates the configuration of still another Helmholtz resonator 120 according to the present disclosure. The Helmholtz resonator 120 is different from the Helmholtz resonator 12 according to the first embodiment in the number of surfaces of a sound source member used as a wall forming a Helmholtz resonance chamber H. That is to say, in this example, a wall 122 forming the resonance chamber H is configured by a sound source member 124 and a soundproof cover 126, and two surfaces of the wall 122 are formed by using the sound source member 124. As an example, it is assumed that the soundproof cover 126 is formed in an L-shaped cross-sectional shape as shown in FIG. 20 so as to extend in a direction perpendicular to the plane of the drawing, and that each end portion of the soundproof cover 126 in a direction perpendicular to the plane of the drawing is closed by another portion (not shown) of the soundproof cover 126. A first opening 128 is formed in one surface of the soundproof cover 126 facing one surface of the sound source member.

FIG. 21 is a cross-sectional view that schematically illustrates the configuration of yet another Helmholtz resonator 130 according to the present disclosure. The Helmholtz resonator 130 is different from the Helmholtz resonator 120 shown in FIG. 20 in the position of the first opening. That is to say, in this example, first openings 132 are respectively formed by using a gap between an end portion 134a of a soundproof cover 134 and the sound source member 124 facing the end portion 134a, and a gap between an end portion 134b and the sound source member 124 facing the end portion 134b.

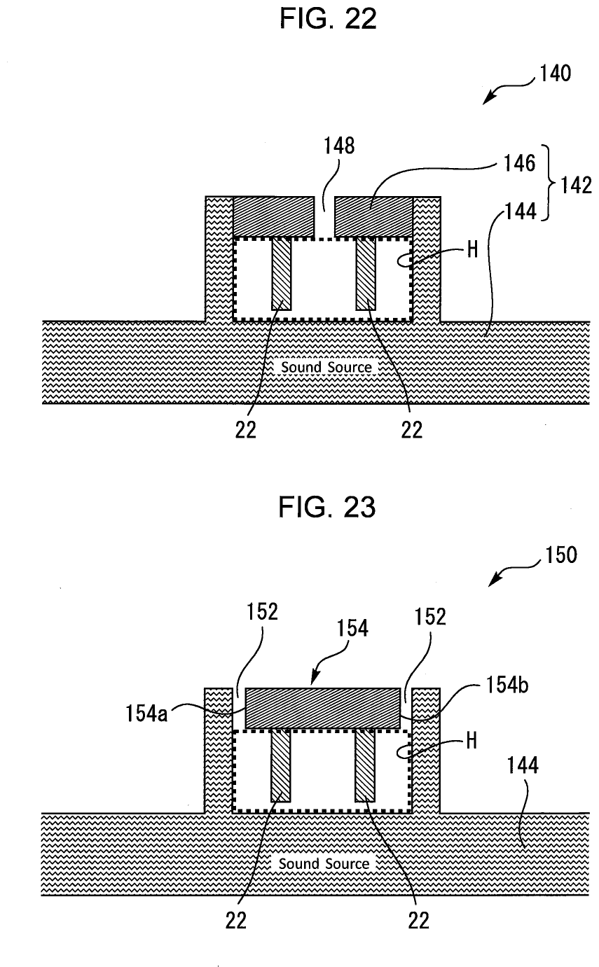

FIG. 22 is a cross-sectional view that schematically illustrates the configuration of still another Helmholtz resonator 140 according to the present disclosure. In the example of this Helmholtz resonator 140, a wall 142 forming a resonance chamber H is formed by a sound source member 144 and a soundproof cover 146, and three surfaces of the wall 142 are formed by using the sound source member 144. As an example, it is assumed that the soundproof cover 146 has a cross-sectional shape (flat plate shape) as shown in FIG. 22 and is formed so as to extend in a direction perpendicular to the plane of the drawing, and each end portion of the soundproof cover 146 in a direction perpendicular to the plane of the drawing is closed by another portion (not shown) of the soundproof cover 146. A first opening 148 is formed in one surface of the soundproof cover 146 facing one surface of the sound source member 144.

FIG. 23 is a cross-sectional view that schematically illustrates the configuration of yet another Helmholtz resonator 150 according to the present disclosure. The Helmholtz resonator 150 is different from the Helmholtz resonator 140 shown in FIG. 22 in the position of the first opening. That is to say, in this example, first openings 152 are respectively formed by using a gap between an end portion 154a of a soundproof cover 154 and the sound source member 144 facing the end portion 154a, and a gap between an end portion 154b and the sound source member 144 facing the end portion 154b.

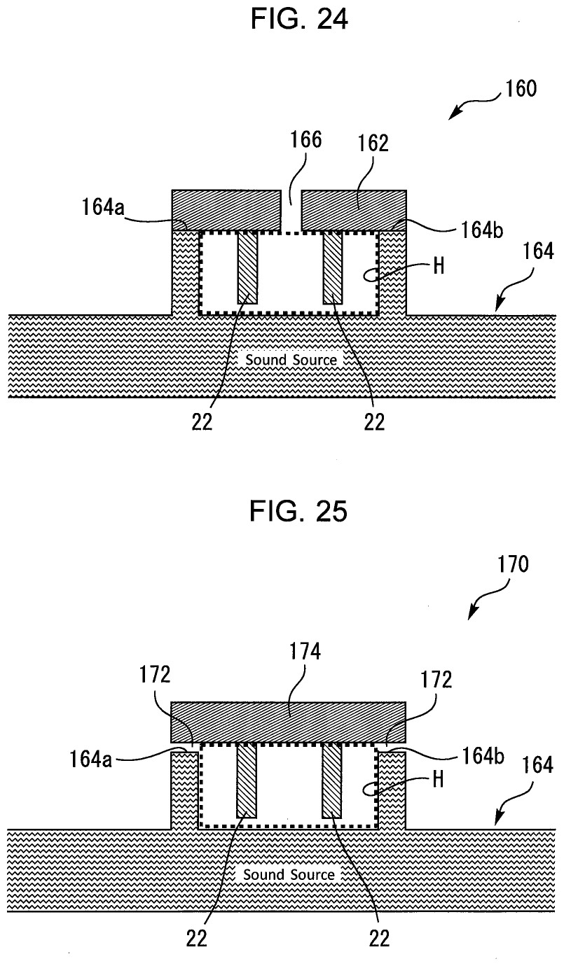

FIG. 24 is a cross-sectional view that schematically illustrates the configuration of still another Helmholtz resonator 160 according to the present disclosure. The Helmholtz resonator 160 is different from the Helmholtz resonator 140 shown in FIG. 22 in the manner of joining the sound source member and the soundproof cover. That is to say, in this example, a soundproof cover 162 is arranged on the respective end portions 164a and 164b of two surfaces of a sound source member 164 that protrudes toward the soundproof cover 162. A first opening 166 is formed in one surface (the largest surface) of the soundproof cover 162 facing the one surface of the sound source member 164.

FIG. 25 is a cross-sectional view that schematically illustrates the configuration of yet another Helmholtz resonator 170 according to the present disclosure. The Helmholtz resonator 170 is different from the Helmholtz resonator 160 shown in FIG. 24 in the position of the first opening. That is to say, in this example, first openings 172 are respectively formed by using a gap between the end portion 164a of the sound source member 164 and a soundproof cover 174 facing the end portion 162b, and a gap between the end portion 162b and the soundproof cover 174 facing the end portion 164a.

Furthermore, although illustration is omitted, the number of surfaces of the sound source member used as a wall forming the Helmholtz resonance chamber H may be four or more instead of the examples described above, or the whole of the wall may be configured by a sound source member. The number of partition walls provided for dividing a Helmholtz resonance chamber H into a plurality of regions may not always be plural, and may be one (for example, one flat plate).

The embodiments and modification examples described above may be combined in other ways than those explicitly described above as required and may be modified in various ways without departing from the scope of the present disclosure.

What is claimed is:

1. A soundproofing device, comprising a Helmholtz resonator including:
a wall that forms a Helmholtz resonance chamber; and
a first opening formed in the wall so as to cause the Helmholtz resonance chamber to communicate with an outside of the Helmholtz resonance chamber,
wherein at least a part of the wall is configured by a sound source member that radiates sound, and
wherein the Helmholtz resonator includes:
one or more partition walls formed so as to divide the Helmholtz resonance chamber into a plurality of regions, and
a second opening formed in the one or more partition walls so as to cause the plurality of regions to communicate with each other.

2. The soundproofing device according to claim 1,
wherein the Helmholtz resonance chamber includes a first direction and a second direction shorter than the first direction, and
wherein at least one of the one or more partition walls is formed so as to extend in a direction perpendicular to the first direction.

3. The soundproofing device according to claim 1,
wherein the one or more partition walls include a plurality of partition walls, and
wherein the plurality of partition walls are arranged at unequal intervals.

4. The soundproofing device according to claim 1,
wherein the plurality of regions include a first region, and one or a plurality of second regions located outside the first region, and
wherein the first region is wholly covered by the one or a plurality of second regions with at least one of the one or more partition walls interposed between the first region and the one or a plurality of second regions.

5. The soundproofing device according to claim 1,
wherein the one or more partition walls have a honeycomb cross-sectional shape.
